(19) United States
(12) Patent Application Publication
(10) Pub. No.: US 2008/0181363 A1
(43) Pub. Date: Jul. 31, 2008

(54) Surface topography with X-ray reflection phase-contrast microscopy

(75) Inventors: Paul Fenter, Naperville, IL (US); Wenbing Yun, Walnut Creek, CA (US)

Correspondence Address: FOLEY & LARDNER LLP, 321 NORTH CLARK STREET, SUITE 2800, CHICAGO, IL, 60610-4764, US

(73) Assignee: UChicago Argonne, LLC

(21) Appl. No.: 11/657,805

(22) Filed: Jan. 25, 2007

(51) Int. Cl. G01N 23/20

(52) U.S. Cl. 378/70

(57) ABSTRACT

A system and method for monitoring a surface or interfacial area. The system and method includes an intense X-ray beam directed to a surface or interface at a low angle to achieve specular reflection with phase contrast associated with an event, such as changing topography, chemistry or magnetic state being detected by a CCD. Upstream or downstream processing can be carried out with the X-ray phase contrast system.

This invention was made with government support under Contract No. W-31-109-ENG-38 awarded to the Department of Energy and the U.S. Government has certain rights in this invention.

The present invention is related generally to an improved system and method for inspecting and monitoring interfacial processes. More particularly the invention is concerned with X-ray reflection interface microscopy to inspect and monitor interfacial solid state processes.

### BACKGROUND OF THE INVENTION

A challenge of interfacial technology is the direct and non-invasive observation of interfacial processes relevant to natural and industrial processes in the real environment of interest. Interfacial reactivity is central to many natural and industrial processes. For example, mineral surface reactivity controls the release of primary nutrients, transport of contaminants in natural waters, and formation of bone and skeletal minerals. In another area, corrosion constitutes a major industrial cost, including the transportation and production of petroleum products, operation of power plants, the stability of nuclear materials. In yet another area, heterogeneous catalysis can mitigate the effects of fossil fuel consumption through development of catalysts with high efficiency and selectivity due to nano-particle size and shape. A necessary requirement for understanding interfacial reactivity is the ability to distinguish elementary steps from terraces, but these phenomena take place in complex environments that are inaccessible to most high spatial-resolution interfacial probes. The ability to observe such phenomena in-situ and in real time, with sensitivity to molecular-scale features and processes, would substantially improve our ability to understand, and ultimately control such processes.

Scanning probe microscopy techniques are widely used to image interfacial reactivity in non-vacuum environments, but their application can be limited either by artifacts that arise from tip-induced phenomena or, more generally, because of tip reactivity in aggressive chemical environments. Optical interferometric techniques observe topographical changes to interfaces in contact with fluids, but without sensitivity to individual molecular-scale features. Electron microscopy is highly advanced but is limited to vacuum environments. X-rays and neutrons offer substantial opportunities as non-invasive probes in complex environments due to their highly penetrating nature and direct sensitivity to molecular-scale features; but these approaches have relied mostly on statistically averaging measurements such as X-ray scattering and spectroscopy. The recent development of X-ray sources and optics has led to new opportunities to image a wide range of structures and processes using X-ray microscopy. Application of these approaches to interfacial structures has been limited to observation of meso- and nanoscopic structures (e.g., as small as tens of nanometers) due to limitations in X-ray optics, including the minimum focused beam size in a scanning X-ray microscope, or the spatial resolving power in a full field imaging microscope.

### SUMMARY OF THE INVENTION

X-ray microscopy can be used to image the distribution of molecular-scale interfacial features directly and non-invasively with full field imaging. Interfacial phase contrast from elementary defect structures allows direct observation of at least 0.6 nm-high monomolecular steps at a solid surface. This non-invasive technique opens up new opportunities to study interfacial processes in-situ and in real-time, particularly those taking place under aggressive chemical conditions which currently can only be studied by ex-situ approaches.

The objects and advantages of the invention are further described hereinafter in more detail, and preferred embodiments of the invention are illustrated in the drawings hereinbelow described.

### BRIEF DESCRIPTION OF THE DRAWINGS

FIG. 1A illustrates a schematic of an X-ray reflection interface microscope in accordance with one embodiment of the invention; FIG. 1B illustrates a schematic of the mechanism for interfacial phase contrast with a focused X-ray beam reflecting from either side of a topographical step on a material surface, but within a single resolution volume, creating destructive interference; and FIG. 1C shows specular reflectivity calculations for a flat, smooth surface, changes in local reflectivity at the monomolecular level and double height steps;

FIG. 2A shows surface topographic images of an orthoclase (001) surface using the method of the invention for an incident X-ray angle of 1.4°; FIG. 2B is for an incident X-ray angle of 1.8°; FIG. 2C is for an incident X-ray angle of 2.7° and FIG. 2D is for an incident X-ray angle of 3.3°; and

FIG. 3A shows line scans across features identified by selected boxes in FIGS. 2A-2D for the incident angles of 1.4°, 1.8°, 2.7° and 3.3° and also for 2.2° corresponding to L=4 (image not shown in FIGS. 2A-2D); FIG. 3B shows a line scan across the box of FIG. 2A, lower left corner with the line being a guide to the eye; FIG. 3C shows observed contrast plotted as a function of vertical momentum transfer, L, with multiple data points representing distinct areas along the same step with the lines the expected contrast variation for a monomolecular (N=1, solid line) and double height (N=2, dotted line) steps; and FIG. 3D is calculated reflectivity derived from the orthoclase (001) water interface.

### DETAILED DESCRIPTION OF PREFERRED EMBODIMENTS

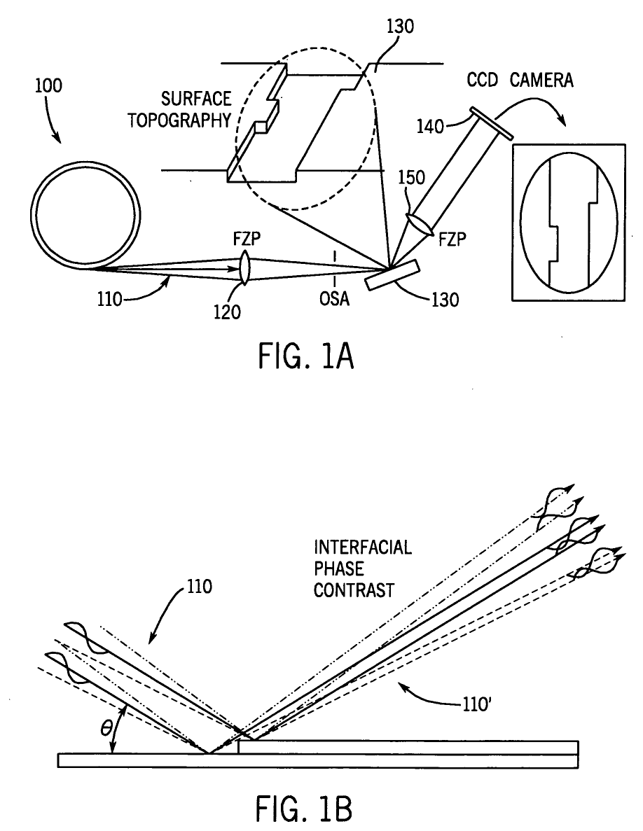

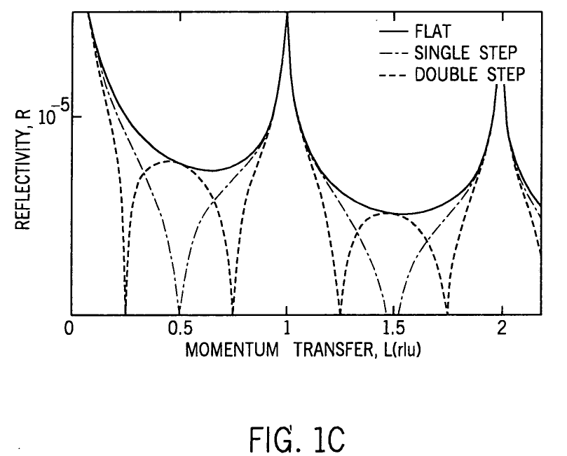

In a preferred form of the invention, X-ray phase optics can be modified to utilize contrast derived from elementary defects as a method for imaging the spatial distribution of molecular-scale interfacial and surface features with full field X-ray microscopy. This approach is illustrated by imaging elementary steps on a surface using a specularly reflected X-ray beam, with an X-ray reflection interface microscope (XRIM) system 100 shown schematically in FIG. 1A. This XRIM system 100 focuses a monochromatic X-ray beam 110 using a well-known condenser Fresnel zone plate (FZP) lens 120 to a small micron-sized spot (typically about 10 micrometers) on sample 130. A magnified image of the surface of the sample 130 is projected on an X-ray area detector, such as a CCD camera 140 with an objective FZP lens 150 using the weak specularly reflected X-ray beam 110′ (see FIG. 1B), thereby imaging the spatial variation of the local X-ray reflectivity across the surface. Sensitivity to vertical changes in surface topography derives from phase contrast, i.e., due to the difference in X-ray path length for the X-ray beam 110′ reflected from neighboring terraces on either side of a step. This results in destructive interference in the X-ray beam 110′ in far field. Variations in surface topography of the sample 130 are therefore seen by the incident X-ray beam 110 as a pure phase object with a sudden phase change across the step. Kinematic X-ray scattering calculations show the essential strengths and challenges of this approach (see FIG. 1C). Specular reflectivity calculations are shown in FIG. 1C for an ideally smooth surface (-), and the changes in local reflectivity at monomolecular (----) and double-height steps (-). The data are plotted vs. L, which is related to the vertical momentum transfer by Q=(2π/d)L, where d=0.6464 nm is the orthoclase (001) lattice spacing. While hard X-ray imaging normally uses strong transmitted or the Bragg reflected X-ray beams 110′, here, interfacial phase contrast is obtained by imaging the weak interface-reflected X-ray beam 110′ that is >5 orders of magnitude weaker than the incident X-ray beam 110. The potentially strong variation in the local reflected intensity due to reflection at a step, with theoretical contrast as high as 100%, can effectively compensate for the weak surface reflectivity. Nevertheless, the ability to use phase contrast to image an interface of the sample 130 depends critically on the source brilliance and the efficiency of the X-ray optics and detector systems. In spite of these potential difficulties, order of magnitude estimates reveal that one might obtain images in seconds when the reflectivity is ˜10⁻⁵, and proportionally longer at lower reflectivity.

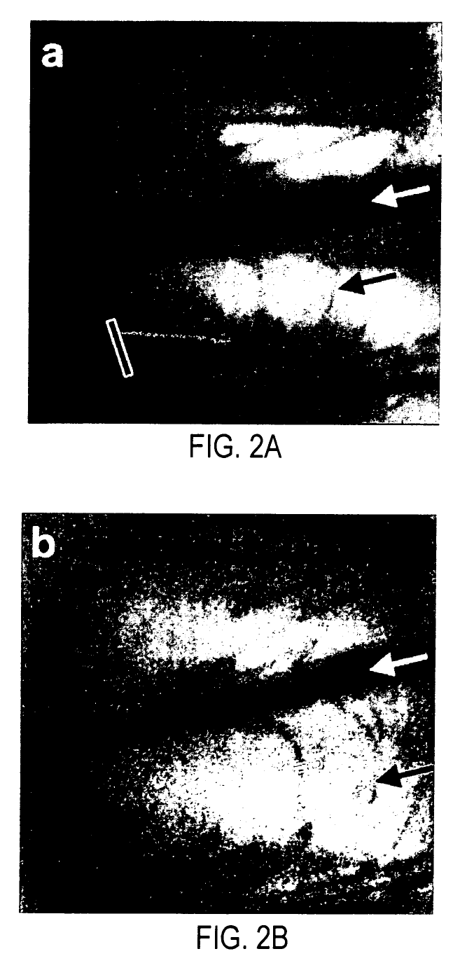

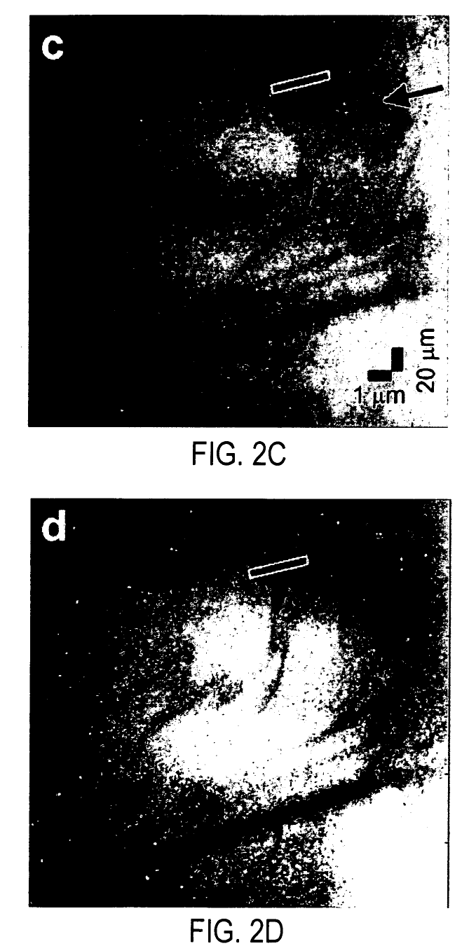

The feasibility of this approach is demonstrated by imaging the (001) surface of the sample 130, in this example orthoclase, KAlSi₃O₈, in air at incident angles of θ=1.4°, 1.8°, 2.7° and 3.3° with a photon energy of 10.0 keV (see FIGS. 2A-2D, respectively). Previous studies have shown this surface of the sample 130 to be extremely flat with a topography having molecularly-sharp steps that are ideal to evaluate the performance of the system 100. The same patterns are observed in each image, including straight lines and an intricate pattern of curved lines. These features appear to arise from the orthoclase surface since the images are obtained by bright field imaging using the interface sensitive X-ray beam 110′, and wedged shaped mesa topographies are observed (black arrows in FIGS. 2A-2D) similar to that seen previously by atomic force microscopy. Sensitivity also exists to bulk defects within the penetration depth of the incident beam (e.g., dislocations buried beneath the surface). The observed patterns, however, are identical after correction for angle dependent perspective as would be expected for two-dimensional structures at different grazing angles [e.g., ˜1/sin(θ)]. This perspective controlled by the grazing angle results in an asymmetry in the spatial resolution within the surface plane of the sample 130 (i.e., along the vertical and horizontal axes of the images). These images were obtained in ˜2-10 minutes each, and smaller areas were imaged in 10 sec with some cost of the signal-to-noise ratio. We expect that similar quality images can be obtained in <1 second with planned instrumental improvements. Consequently this provides a way to observe real-time changes to surface topography associated with molecular-scale processes (e.g., adsorption, dissolution, and precipitation).

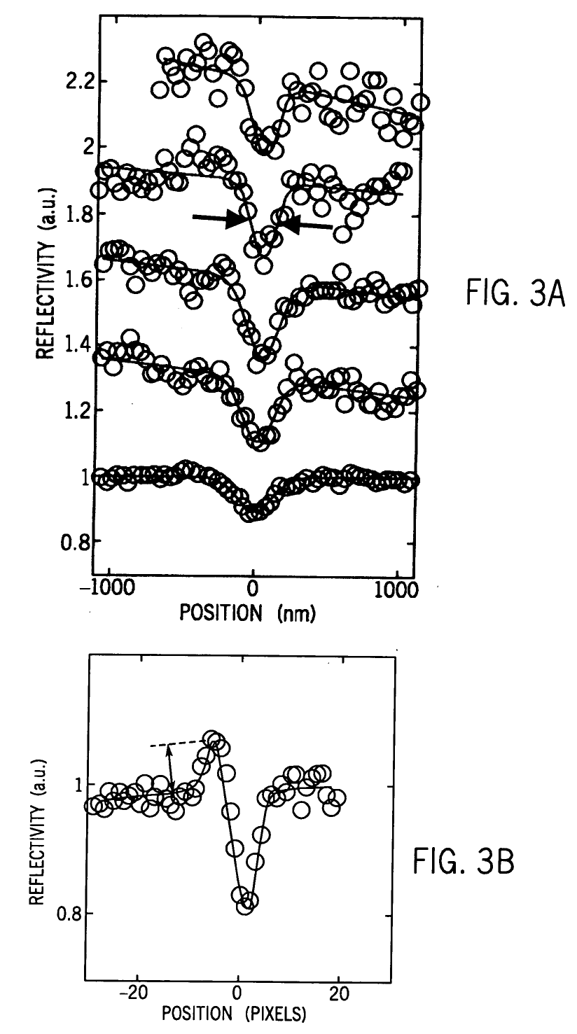

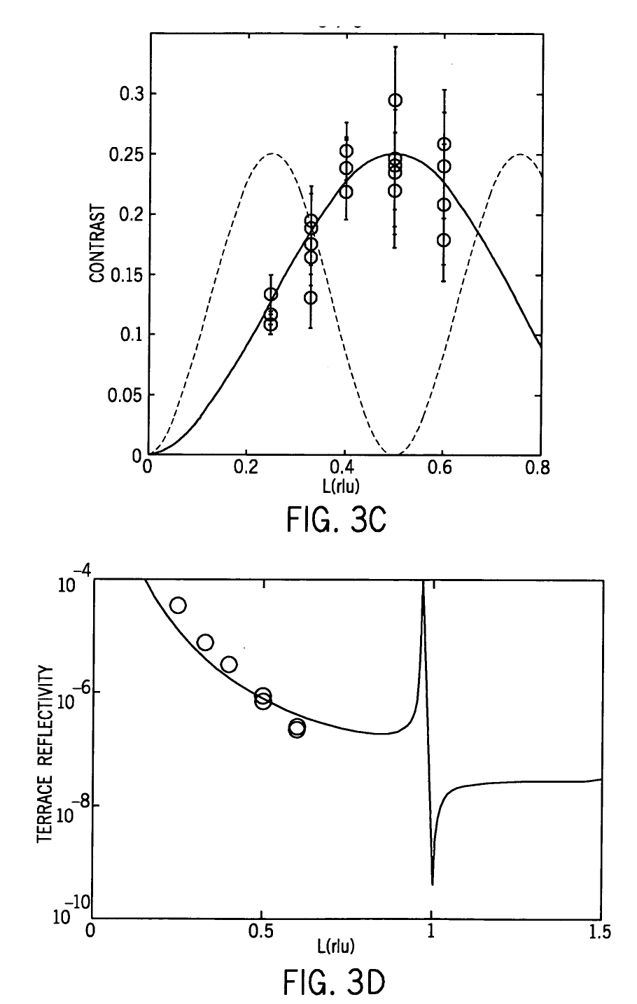

An important feature of this approach is that image intensities can be quantified with kinematic diffraction theory. In the present case, the sensitivity to vertical topographical changes (e.g., steps) can be derived by considering phase contrast of the reflected X-ray beam 110′ reflected near a step (see FIG. 1B). The X-ray beam 110′ reflected from neighboring terraces of the sample 130 separated by a monomolecular step are in-phase (i.e., invisible) when the momentum transfer, Q=(4π/λ)sin(θ)=(2π/d)L, corresponds to the Bragg condition, i.e., with L=1, 2 . . . , but are out-of-phase (i.e., visible) near the “anti-Bragg” conditions, L=½, 3/2, etc. (where λ is the X-ray wavelength, and d=0.6464 nm is the substrate vertical layer spacing). More generally, the phase change at the step, with height Nd, is characterized by Φ=QNd=2πNL, and the resulting fractional variation of intensity across an N-layer high step (i.e., the contrast, C) can be calculated assuming ideal geometrical optics as C=Cₒ sin²(πNL) where Cₒ is the maximum contrast (ideally, Cₒ=1), allowing step heights to be identified directly. This is illustrated with the isolated curved features highlighted in FIGS. 2A-2D, which is chosen since it is largely aligned with the X-ray beam 110 direction and the foreshortening of the image due to the perspective view does not complicate the interpretation of resolution. Line-scans across the step (see FIG. 3A) show that the fractional change in reflectivity varies systematically with the scattering condition (see FIG. 3C). Line scans across features are identified in FIG. 3A by rectangular boxes in FIGS. 2A-2D whose largest edge is parallel to the arrows and for FIG. 3B for the box in lower left corner of FIG. 2A. The data are shown for incident angles of 1.4°, 1.8°, 2.7° and 3.3° (corresponding to L=0.25, 0.33, 0.5, and 0.6 with vertical offsets (with respect to 1) of 0, 0.3, 0.6, 0.9, and 1.2, respectively) and also for 2.2° corresponding to L=0.4 (image not shown). The data points show signals (in nominal X-ray counts) that are averaged within the box transverse to the scan direction and normalized to the reflectivity far from a step. The lateral instrumental resolution transverse to the scattering plane is indicated by the arrows in FIG. 3A, and the solid lines through the data points in FIG. 3A are fits with the sum of Gaussian and linear functions. The solid line going through the data points in FIG. 3B is a guide to the eye; FIG. 3C is for observed contrast; and for FIG. 3D, terrace reflectivity, are plotted as a function of the vertical momentum transfer, L, with multiple data points representing distinct areas along the same step. The lines in FIG. 3C are the expected contrast variation for a monomolecular (N=1, solid line) and double height (N=2, dashed line) steps on the sample 130, calculated with Cₒ=0.25. The vertical error bars are the statistical uncertainty in the contrast derived through propagation of errors derived from counting statistics in the images of the CCD camera 140. The line in FIG. 3D is the calculated reflectivity (in absolute units) derived from the orthoclase (001)-water interface, but without fluid water above the surface to approximate the conditions of the experiment. The measured reflectivity data are estimated based on the measured signal and counting time, without corrections for variations in illumination or detector efficiency with an overall scale factor, showing the expected 100-fold variation of signal with vertical momentum transfer.

The observed contrast variation is well-described with N=1, corresponding to a monomolecular step on the sample 130, with a maximum contrast of Cₒ=0.25, and is distinct from that for other step heights (e.g., a double step, N=2) that show a more rapid oscillation in contrast. This identification is also supported by previous studies of the orthoclase-water interface in which wedge-shaped mesas defined by monomolecular steps (black arrows, FIGS. 2A-2D) are a common feature of cleaved (001) surfaces. Consequently, while the lateral resolution of the system 100 is limited by instrumental details (at ˜200 nm), the variation of phase contrast with vertical momentum transfer allows this 0.6 nm high monomolecular step on the sample 130 to be identified by intensity contrast. The observed step width at L=0.5 is ˜200 nm (indicated by arrows in FIG. 3A), which is twice the expected resolution of the system 100 (thereby explaining much, but not all, of the reduced contrast). The reflectivity far from a step, meanwhile, varies strongly with the incident angle and follows the functional form for specular reflectivity determined by the intrinsic molecular-scale interfacial structure (see FIG. 3D).

The imaging mechanism has been described from an interfacial scattering perspective where the X-ray beam 110′ scattered by a step on the sample 130 will contribute to diffuse scattering at the expense of the specularly reflected X-ray beam 110′. This is complementary to the perspective of geometrical optics in which the finite numerical aperture of the objective FZP 150 will effectively reject any diffuse scattering, thereby leading to a reduction of the local specular reflectivity near steps on the sample 130 with an image contrast that is directly related to the phase change at each step.

The present results demonstrate an advantageous approach for extending the system 100 for a variety of applications. For example, one can observe the distribution of molecular-scale features on a solid surface of the sample 130, in this case elementary steps that are ˜300-fold smaller than the experimental resolution. The ability to image elementary steps in real-time is expected to lead to new opportunities for understanding interfacial reactivity. Further, one can observe step dynamics (e.g., during crystal growth and dissolution in aqueous solutions at extreme pH) which can provide new information about surface reactivity. Interfacial phase contrast can conceivably be optimized to highlight various structures, including defect distributions at buried solid-solid interfaces (e.g., dislocations) and the nucleation and growth of nano-particles. For instance, nano-particle Bragg diffraction can identify the growth and habit of particle nucleation (e.g., nucleation at steps or on terraces) as might be seen by scanning probe microscopy. This can also be used to identify the crystal phase and orientation of that particle, as would be necessary to understand hetero-epitaxy of particle nucleation and the size-dependent relative stability of compositionally equivalent phases (e.g., calcite vs. aragonite; rutile vs. anatase). In a similar way, contrast derived from resonant anomalous dispersion of the X-ray beam 110′ can be used to highlight elemental, chemical, or magnetic features of an interface which would be useful to probe various interfacial processes such as ion adsorption, corrosion, catalytic reactions, magnetic domain growth, and ferroelectric domain switching. In particular, this non-invasive system 100 opens up the possibility of observing interfacial reactions under aggressive chemical conditions inaccessible to probe microscopies due to probe tip reactivity. The ability to measure reflectivity over microscopic regions of a surface of the sample 130 also suggests performing interfacial structural analyses of small grained materials (e.g., clays, zeolites) whose reactivity is important by virtue of their large intrinsic surface area, but whose interfaces have remained largely inaccessible to traditional structural probes. Direct observations of many important interfacial processes can be obtained with this approach, thereby bringing new clarity to many processes that previously could only be understood indirectly through ex-situ, destructive, or spatially averaging measurements. Such range of utility further allows upstream system 200 and downstream processing system 210 (see FIG. A) for the sample 130 by virtue of a central loop using the system 100 as part of a large industrial application.

The following non-limiting example illustrates a preferred method of using the invention.

### EXAMPLE

X-ray reflection contrast microscopy experiments were carried out at beamline 12-ID-D (BESSRC) at the Advanced Photon Source (APS) at Argonne National Laboratory in December, 2005. The APS undulator was set with its first harmonic at 10 keV. The X-ray beam was reflected from a nominally unfocused horizontal deflection high heat load mirror, and a monochromatic beam with a photon energy of 10.0 keV was selected with a silicon (111) double bounce monochromator. The sample was prepared by cleaving gem-quality orthoclase (KAlSi₃O₈) to reveal a fresh (001) surface and mounted on a sample holder and held in place with epoxy. The sample was mounted on a four-circle diffractometer so that the incident angle of the beam with respect to the sample surface could be precisely controlled and measurements were performed with the sample in contact with air. The reflected beam was imaged using an area detector mounted on the diffractometer detector arm.

It should be understood that the above description of the invention and specific example and embodiments, while indicating the preferred embodiments of the present invention are given by demonstration and not limitation. Many changes and modifications within the scope of the present invention may therefore be made without departing from the spirit thereof and the present invention includes all such changes and modifications.

What is claimed is:

1. A method of monitoring a surface of a material, comprising the steps of:
providing an X-ray beam;
positioning a sample such that the X-ray beam strikes a surface of the material within a specular reflection angular range;
projecting a magnified image of the surface of the material onto an X-ray detector; and
detecting an event at the surface of the material by phase contrast arising from difference in path lengths of the specularly reflected X-ray beam.

2. The method as defined in claim 1 wherein the X-ray beam comprises an intense X-ray beam.

3. The method as defined in claim 1 wherein the X-ray beam consists essentially of a monochromatic radiation.

4. The method as defined in claim 1 further providing an intense pulsed X-ray source for the X-ray beam.

5. The method as defined in claim 1 further providing a Fresnel zone plate lens for focusing the X-ray beam to a small spot.

6. The method as defined in claim 1 further providing an objective lens for processing an X-ray beam specularly reflected from the sample.

7. The method as defined in claim 1 wherein the X-ray detector comprises a charge coupled device (CCD).

8. The method as defined in claim 1 further including the step of processing the sample in view of the events detected.

9. The method as defined in claim 1 wherein the event comprises a change in topography.

10. The method as defined in claim 1 wherein the event comprises a chemical change.

11. The method as defined in claim 1 wherein the chemical change comprises a catalytic event.

12. The method as defined in claim 1 wherein the event comprises a magnetic event.

13. The method as defined in claim 12 wherein the magnetic event comprises at least one of magnetic domain growth and ferroelectric domain switching.

14. The method as defined in claim 1 wherein the event comprises at least one of a dynamic event and a static event.

15. The method as defined in claim 1 wherein the material surface comprises a buried interface.

16. A method of monitoring an interfacial area of a material, comprising the steps of:
providing an interfacial sample area;
providing an intense X-ray source;
generating a monochromatic X-ray beam from the intense X-ray source;
striking the interfacial material area with the X-ray beam within a specular reflection angular range;
collecting a specularly reflected X-ray beam by an X-ray detector; and
analyzing the collected X-ray beam to monitor an event at the interfacial material area.

17. The method as defined in claim 16 further including at least one of upstream processing and downstream processing of the material surface area.

18. The method as defined in claim 16 wherein the event is selected from the group of monitoring a catalytic event, a magnetic event, a chemical event and a topographical event.

19. The method as defined in claim 16 further including the step of providing optics to form a focused small X-ray beam for striking the interfacial material area.

20. The method as defined in claim 16 wherein the step of analyzing the interfacial material area comprises detecting differences of phase contrast.
